(19) United States
(12) Patent Application Publication
(10) Pub. No.: US 2011/0053764 A1
(43) Pub. Date: Mar. 3, 2011

(54) POROUS ALUMINUM MATERIAL HAVING IMPROVED BENDING STRENGTH AND PRODUCTION METHOD THEREFOR

(75) Inventors: Toshifumi Taira, Osaka (JP); Masashi Mehata, Osaka (JP)

(73) Assignee: TOYO ALUMINIUM KABUSHIKI KAISHA, Osaka (JP)

(21) Appl. No.: 12/871,237

(22) Filed: Aug. 30, 2010

(30) Foreign Application Priority Data
Sep. 3, 2009 (JP) 2009-203683

(51) Int. Cl. B01J 21/06; H01B 1/02

(52) U.S. Cl. 502/263; 252/512

(57) ABSTRACT

The present invention provides a porous aluminum material composed of a sintered body having an improved bending strength, and a production method therefor, wherein the sintered body comprises an aluminum alloy having an Si content of 100 to 3,000 ppm.

### TECHNICAL FIELD

The present invention relates to a porous aluminum material having an improved bending strength. The porous aluminum material of the present invention is useful as an electrode material for an aluminum electrolytic capacitor, a catalyst support and the like. The present invention also provides a production method for the porous aluminum material.

### BACKGROUND ART

Aluminum electrolytic capacitors are widely used because they allow a high capacity to be achieved at a low cost. Aluminum foil is generally used as an electrode material for an aluminum electrolytic capacitor.

The surface area of the electrode material for an aluminum electrolytic capacitor can usually be increased by performing an etching treatment to form etching pits. The etched surface of the electrode material is then anodized to obtain an oxide film that functions as a dielectric substance. By etching the aluminum foil and applying one of various voltages to the surface thereof to match the voltage that is to be used, an anodic oxide film can be formed, thus enabling various aluminum anodes (foils) to be produced for electrolytic capacitors that are suited to specific applications.

In the etching process, pores called etching pits are formed in the aluminum foil, and the etching pits are processed into various shapes depending on the anodization voltage to be applied.

More specifically, a thick oxide film must be formed for use in medium- to high-voltage capacitors. Therefore, in order to prevent the etching pits from being buried by such a thick oxide film, the etching pits for an aluminum foil that is to be used in a medium- to high-voltage anode are made to a tunnel type by conducting direct-current etching, and then processed to have an appropriate size for the voltage that is to be used. In contrast, small etching pits are necessary for use in low-voltage capacitors. Therefore, sponge-like etching pits are generally formed by alternating-current etching. In a cathode foil, the surface area is similarly increased by etching.

However, the etching treatments for both anodes and cathodes require the use of an aqueous hydrochloric acid solution that contains sulfuric acid, phosphoric acid, nitric acid, etc., in hydrochloric acid. Hydrochloric acid has a strong environmental impact, and its disposal also impacts the production process or production cost. Therefore, the development of a porous aluminum foil that does not require etching is in demand.

In order to meet this demand, the use of an aluminum electrolytic capacitor that is characterized by adhering a fine aluminum powder to the surface of an aluminum foil has been proposed (Patent Document 1). Another example of a known electrolytic capacitor is one that uses an electrode foil that comprises a flat aluminum foil having a thickness of not less than 15 μm but less than 35 μm, wherein an aggregate of self-similar aluminum fine particles having a length of 2 to 0.01 μm and/or an aggregate of aluminum fine particles having an aluminum oxide layer formed on the surface thereof are adhered to one or both surfaces of the flat aluminum foil (Patent Document 2).

However, the methods disclosed in the aforementioned documents, wherein aluminum powder is adhered to the aluminum foil by plating and/or vacuum evaporation, are insufficient, at least for obtaining thick etching pits for medium- to high-voltage capacitors.

Alternatively, an electrolytic capacitor electrode material that is made from a sintered body of at least one member selected from the group consisting of aluminum and aluminum alloys, has been proposed (Patent Document 3). This electrode material is inherently porous because it is made from a sintered body; therefore, it can be used as an electrode for an aluminum electrolytic capacitor by merely anodizing it, without the need for etching.

However, the electrolytic capacitor electrode material of Patent Document 3 is inferior to known etched foils in terms of bending strength. In order to increase the electrostatic capacity, the use of very small particles of aluminum and an aluminum alloy is necessary; therefore, it is difficult to improve both the electrostatic capacity and the bending strength at the same time.

The aluminum material made from the sintered body described above is expected to find applications not only as an electrode material for an electrolytic capacitor but also as a catalyst support and other applications by utilizing porous characteristics derived from three-dimensional through-holes formed therein.

One example of a conventional technique in which a porous aluminum material is used as a support for a catalyst body is an application for purifying polluted air, wherein the catalyst support is formed by subjecting an aluminum substrate to an etching treatment to form etching pits perpendicular to the surface of the aluminum substrate (Patent Document 4). More specifically, after increasing the surface area of the aluminum substrate by etching, a film having very small pores is formed by anodization. Thereafter, the aluminum substrate is made to support platinum, palladium and the like in the small pores thus formed, thereby obtaining a catalyst body. However, when pits are formed perpendicular to the surface of the substrate as disclosed in Patent Document 4, air passes only in the thickness direction of the substrate. Therefore, in order to increase the distance over which the air travels, it is necessary to stack a plurality of substrates.

In contrast, there is no restriction on the direction in which air travels in an aluminum material made from a sintered body having three-dimensional through-holes. Therefore, an aluminum material made from a sintered body may also be wound to any desired width, and the width will determine the traveling distance of the air.

Improving the bending strength (bending processability) is also desired in order to allow such a wide range of applications.

In view of the problems described above, the development of a porous aluminum material that is made from the aforementioned sintered body and that has an improved bending strength, and a production method therefor is desired.

### Citation List

Patent Document

Patent Document 1: Japanese Unexamined Patent Publication No. 1990-267916

Patent Document 2: Japanese Unexamined Patent Publication No. 2006-108159

Patent Document 3: Japanese Unexamined Patent Publication No. 2008-98279

Patent Document 4: Japanese Unexamined Patent Publication No. 2008-126151

### DISCLOSURE OF THE INVENTION

### Problem to Be Solved by the Invention

An object of the present invention is to provide a porous aluminum material that is made from a sintered body and that has an improved bending strength, and a method for producing such a porous aluminum material.

### Means for Solving the Problem

The present inventors conducted extensive research, and found that a sintered body of a specific aluminum alloy can achieve the above object. The present invention was accomplished based on this finding.

Specifically, the present invention relates to the following porous aluminum materials and production methods therefor.

Item 1. A porous aluminum material comprising a sintered body of an aluminum alloy having an Si content of 100 to 3,000 ppm by weight.

Item 2. The porous aluminum material according to Item 1, wherein the sintered body is formed by sintering the aluminum alloy particles while maintaining a space between each particle.

Item 3. The porous aluminum material according to Item 1 or 2, wherein the sintered body is a foil having an average thickness of not less than 20 μm and not more than 1,000 μm.

Item 4. The porous aluminum material according to any one of Items 1 to 3, which further comprises a substrate for supporting the aluminum material.

Item 5. The porous aluminum material according to Item 4, wherein the substrate is an aluminum foil.

Item 6. The porous aluminum material according to any one of Items 1 to 5, which is an electrode material for an aluminum electrolytic capacitor.

Item 7. The porous aluminum material according to any one of Items 1 to 5, which is a catalyst support.

Item 8. A method for producing a porous aluminum material, comprising the steps of:

Step (1): forming a film made from a composition comprising an aluminum alloy powder having an Si content of 100 to 3,000 ppm by weight on a substrate; and

Step (2): sintering the film at a temperature not lower than 560° C. and not higher than 660° C.

Item 9. The production method according to Item 8, wherein the powder has an average particle diameter of not less than 0.5 μm and not more than 100 μm.

Item 10. The production method according to Item 8 or 9, wherein the composition comprises at least one member selected from the group consisting of resin binders and solvents.

The porous aluminum material of the present invention and the production method therefor are explained in detail below.

### 1. Porous Aluminum Material

The porous aluminum material of the present invention is made from a sintered body of an aluminum alloy having an Si content of 100 to 3,000 ppm by weight.

The sintered body essentially consists of an aluminum alloy having an Si content of 100 to 3,000 ppm by weight. In other words, by producing a sintered body using an aluminum alloy powder having an Si content of 100 to 3,000 ppm by weight, a sintered body with improved bending strength compared to conventional ones can be obtained. The sintered body may essentially consist of the aluminum alloy described above, but unavoidable inclusion of an aluminum alloy with a different Si content or aluminum is allowed to the extent that it does not adversely affect the bending strength.

Any known Al alloy powders having an Si content within the above range can be used as the aluminum alloy of the present invention.

The Si content of the aluminum alloy is not limited as long as it falls within the range of 100 to 3,000 ppm by weight, preferably exceeding 100 ppm by weight but not higher than 3,000 ppm by weight, more preferably 110 to 3,000 ppm by weight, and even more preferably 110 to 2,000 ppm by weight. Examples of alloy components other than Si include one or more elements selected from iron (Fe), copper (Cu), manganese (Mn), magnesium (Mg), chromium (Cr), zinc (Zn), titanium (Ti), vanadium (V), gallium (Ga), nickel (Ni), boron (B), zirconium (Zr) and the like. The content of each of these elements, other than Si, is preferably not greater than 100 ppm by weight, and more preferably not greater than 50 ppm by weight. In the present invention, an iron (Fe) content that is as low as possible is preferred. It is preferable that the iron (Fe) content be set to be not more than 80 ppm by weight, and more preferably not more than 50 ppm by weight.

It is preferable that the sintered body be obtained by sintering the aluminum alloy particles while maintaining a space between each particle. In other words, the particles preferably connect to each other while maintaining spaces between themselves to form a three-dimensional network.

By employing such a porous sintered body, when the porous aluminum material of the present invention is used as, for example, an electrode material for an aluminum electrolytic capacitor, sufficient electrostatic capacity can be obtained without the need for etching. When the porous aluminum material of the present invention is used as a catalyst support, the catalytic component can be efficiently dispersed or supported. Furthermore, because the direction in which gas passes is not limited to one direction, the porous aluminum material may be wound to any desired width, thus allowing the traveling distance of the gas to be adjusted by controlling the width.

The porosity of the sintered body can be generally set to a level that is not less than 30% depending on the target application. In terms of the bending strength, the porosity of the sintered body is preferably from 40% to 55%. The porosity can be controlled by, for example, controlling the particle diameter of the aluminum alloy powder, which is the starting material, the components (resin binders) of a paste composition that contains the aluminum alloy powder, and the like.

There is no limitation on the shape of the sintered body; however, a foil-like shape generally having an average thickness of not less than 20 μm and not more than 1,000 μm, and preferably not less than 50 μm and not more than 600 μm, is preferred. The average thickness is determined as the average of the values measured at ten spots using a micrometer.

The porous aluminum material of the present invention may further contain a substrate that supports the porous aluminum material depending on its application. There is no limitation on the substrate; however, when the porous aluminum material of the present invention is used as an electrode material for an aluminum electrolytic capacitor, aluminum foil may be suitably employed. When it is used as a catalyst support or the like, metal foils such as an aluminum foil, resin sheet and the like may be suitably used.

There is no limitation on the aluminum foil that is used as a substrate, and pure aluminum or an aluminum alloy may be used. The aluminum foil used in the present invention includes aluminum alloys that contain a necessary amount of at least one alloy component selected from silicon (Si), iron (Fe), copper (Cu), manganese (Mn), magnesium (Mg), chromium (Cr), zinc (Zn), titanium (Ti), vanadium (V), gallium (Ga), nickel (Ni) and boron (B); and aluminum that contains a limited amount of the aforementioned elements as unavoidable impurities.

Although not limited thereto, the thickness is preferably not less than 5 μm and not more than 100 μm, and more preferably not less than 10 μm and not more than 50 μm.

An aluminum foil produced by a known method may be used as the aluminum foil of the present invention. Such an aluminum foil may be obtained by, for example, preparing a molten metal of aluminum or an aluminum alloy comprising the components described above, and casting the molten metal to obtain an ingot, followed by appropriate homogenization. Thereafter, the resulting ingot is subjected to hot rolling and cold rolling, thereby obtaining an aluminum foil.

During the aforementioned cold rolling process, intermediate annealing may be conducted at a temperature within a range of not lower than 50° C. and not higher than 500° C., and preferably not lower than 150° C. and not higher than 400° C. After the cold rolling, an annealing treatment may be further conducted within the temperature range of not lower than 150° C. and not higher than 650° C., and preferably not lower than 350° C. and not higher than 550° C. to obtain a soft foil.

In addition to its use as a catalyst support, the porous aluminum material of the present invention may be used as a low-voltage, medium-voltage or high-voltage aluminum electrolytic capacitor. In particular, the porous aluminum material of the present invention is desirable for use as a medium-voltage or high-voltage (medium- to high-voltage) aluminum electrolytic capacitor.

When used as an electrode for an aluminum electrolytic capacitor, the porous aluminum material of the present invention can be used without applying an etching treatment. More specifically, the porous aluminum material of the present invention may be used as an electrode (electrode foil) as is or by only anodizing it, without the need for etching.

The anode foil using the porous aluminum material of the present invention and a cathode foil can be laminated with a separator therebetween and wound to form a capacitor element, which is dipped into and impregnated with an electrolyte and then housed in a case, which is sealed with a sealing material to obtain an electrolytic capacitor.

The porous aluminum material of the present invention may be used as a catalyst support as is or after being anodized. When the porous aluminum material of the present invention is used for deodorizing or decomposing volatile organic compounds or automobile exhaust gas, palladium, platinum, ruthenium, rhodium, iridium, nickel, cobalt, iron, copper, zinc, gold, silver, rhenium, manganese, tin, alloys thereof, and mixtures thereof may be used as a supported catalyst. The amount and particle diameter of the supported catalyst may be suitably selected depending on the target application of the catalyst and the like. There is no limitation on the method for supporting the catalyst, and known methods such as impregnation (pressure impregnation, decompression impregnation), a sol-gel process, and electrophoresis may be employed.

### 2. Method for Producing Porous Aluminum Material

The method for producing the porous aluminum material of the present invention comprises the steps of:

Step (1): forming a film made from a composition comprising an aluminum alloy powder having an Si content of 100 to 3,000 ppm by weight on a substrate; and

Step (2): sintering the film at a temperature not lower than 560° C. and not higher than 660° C.

### Step 1

In Step 1, a film made from a composition comprising an aluminum alloy powder having an Si content of 100 to 3,000 ppm by weight is formed on a substrate.

There is no limitation on the composition (components contained) to the aluminum alloy as long as it has an Si content of 100 to 3,000 ppm by weight, and the aforementioned compositions (components) can be used.

There is no limitation on the shape of the powder, and a spherical, amorphous, scaly, fibrous, or other shape may be suitably used. Particularly, a powder of spherical particles is preferred. The average particle diameter of the spherical particle powder is preferably not less than 0.5 μm and not more than 100 μm, and more preferably not less than 1 μm and not more than 20 μm. When the porous aluminum material is used as an electrode material for an aluminum electrolytic capacitor, a satisfactory withstand voltage may not be obtained with an average particle diameter that is less than 0.5 μm. Conversely, when the average particle diameter is more than 100 μm, a satisfactory electrostatic capacity may not be obtained.

A powder produced by a known method may be used as the powder described above. Examples of employable methods include an atomizing method, a melt spinning method, a rotating disk method, a rotating electrode method, and other rapid solidification methods; in terms of industrial production, an atomizing method is preferred, and a gas atomizing method is particularly preferred. More specifically, a powder obtained by atomizing molten metal is preferably used.

The composition may contain, if necessary, resin binders, solvents, sintering aids, surfactants, etc. For these, known or commercially available products can be used. In the present invention, the composition is preferably used as a pasty composition comprising at least one member selected from the group consisting of resin binders and solvents. Using such a pasty composition enables the efficient formation of a film. Resin binders are not limited, and suitable examples thereof include carboxy-modified polyolefin resins, vinyl acetate resins, vinyl chloride resins, vinyl chloride-vinyl acetate copolymers, vinyl alcohol resins, butyral resins, polyvinyl fluoride, acrylic resins, polyester resins, urethane resins, epoxy resins, urea resins, phenol resins, acrylonitrile resins, nitrocellulose resins, methylcellulose resins, ethylcellulose resins, benzylcellulose resins, tritylcellulose resins, cyanoethylcellulose resins, carboxymethylcellulose resins, carboxyethylcellulose resins, aminoethylcellulose resins, oxyethylcellulose resins; parafin wax, polyethylene wax, and other synthetic resins or waxes; and tar, glue, sumac, pine resin, beeswax, and other natural resins or waxes. These binders are divided into, depending on the molecular weight, the type of resin, etc., those that volatilize upon heating and those that remain as a residue together with aluminum powder as a result of pyrolysis. They can be used depending on the desired electrostatic characteristics, etc.

Moreover, any known solvents may be used. For example, water as well as organic solvents, such as ethanol, toluene, ketones, and esters, may be used.

The method of forming a film may be suitably selected from known methods depending on the properties of the composition, etc. For example, when the composition is a powder (solid), its green compact may be formed (or thermocompression-bonded) on a substrate. In this case, while the green compact is solidified by sintering, the aluminum powder can also be fixed onto a sheet material. When the composition is in liquid (paste) form, a film can be formed by rolling, brushing, spraying, dipping or the like coating method, or by a known printing method.

The film may be dried at a temperature within a range of not lower than 20° C. to not higher than 300° C., if necessary.

There is no limitation on the thickness of the film; however, the thickness is generally not less than 20 μm and not more than 1,000 μm, and more preferably not less than 20 μm and not more than 200 μm. When the porous aluminum material is used as an electrode material for an aluminum electrolytic capacitor, a satisfactory electrostatic capacity may not be obtained with a thickness that is less than 20 μm. Conversely, when the thickness is greater than 1,000 μm, adhesion of the film to the foil may be insufficient, and cracks may be generated in a subsequent step.

The material of the substrate is not limited, and metal, resin, etc., may be used. In particular, when only the film is remained by volatilizing the substrate during sintering, a resin (resin film) can be used. On the other hand, when the substrate is remained, a metal foil can suitably be used. An aluminum foil is particularly suitably used as a metal foil. When an aluminum foil is used, its composition may be different from or substantially the same as that of the film. In prior to the formation of the film, the surface of the aluminum foil may be roughened. The surface roughening method is not limited, and any known technique, such as washing, etching, blasting, etc., may be employed.

### Step 2

In Step 2, the film is sintered at a temperature not lower than 560° C. and not higher than 660° C.

The sintering temperature is not lower than 560° C. and not higher than 660° C., preferably not lower than 560° C. and lower than 660° C., and more preferably not lower than 570° C. and not higher than 659° C. The sintering time, which varies depending on the sintering temperature, etc., can be suitably determined generally within a range of about 5 to 24 hours.

The sintering atmosphere is not limited and may be selected from a vacuum atmosphere, an inert gas atmosphere, an oxidizing gas atmosphere (air), a reducing atmosphere, etc.; in particular, a vacuum atmosphere or a reducing atmosphere is preferred. The pressure conditions are also not limited and a normal pressure, a reduced pressure, or an increased pressure may be employed.

When the composition contains a resin binder or like organic component, it is preferable to conduct a heat treatment (degreasing treatment) after Step 1 but prior to Step 2, at a temperature within a range of not lower than 100° C. to not higher than 600° C. in such a manner that the temperature range is maintained for not less than 5 hours. The heating atmosphere is not limited and may be selected from a vacuum atmosphere, an inert gas atmosphere, or an oxidizing gas atmosphere. The pressure conditions are also not limited and a normal pressure, a reduced pressure, or an increased pressure may be employed.

### Step 3

The porous aluminum material of the present invention can be obtained in the Step 2 described above. When the porous aluminum material is used as an aluminum electrolytic capacitor electrode material, it can be directly used as an electrode (electrode foil) for an aluminum electrolytic capacitor without etching. Alternatively, the porous aluminum material of the present invention may be anodized in Step 3, if necessary, to form a dielectric, which is used as the electrode material.

There is no limitation on the anodization conditions; however, the anodization may generally be conducted by applying a current of about not less than 10 mA/cm² and not more than 400 mA/cm² to the electrode material for not less than 5 minutes in a boric acid solution with a concentration of not less than 0.01 mol and not more than 5 mol at a temperature of not lower than 30° C. and not higher than 100° C.

### EFFECT OF THE INVENTION

The present invention provides a porous aluminum material made from a sintered body having an improved bending strength. Since such a sintered body is obtained by sintering particles (aluminum alloy powder particles) while maintaining a space between each particle, it has a unique structure wherein three-dimensional through-holes are formed within. This allows the porous aluminum material to be used not only as an electrode material for an aluminum electrolytic capacitor but also as a catalyst support, etc.

### BRIEF DESCRIPTION OF DRAWINGS

FIG. 1 illustrates how the number of bends is counted in the bending test of Test Example 1.

### BEST MODE FOR CARRYING OUT THE INVENTION

The present invention is explained in detail below with reference to Examples and Comparative Examples. However, the scope of the invention is not limited to these Examples.

### EXAMPLES

### Examples 1 to 6 and Comparative Example 1

An aluminum alloy powder (JIS A1080, manufactured by Toyo Aluminium K. K.; Si concentration shown in Table 1 below; 60 parts by weight) having an average particle diameter of 3 μm was mixed with 40 parts by weight of a cellulose-based binder (solvent: toluene, containing 7 wt % of resin components), to produce a coating liquid having a solids content of 60 wt %. The resulting coating liquid was applied to the front and back surfaces of a 30-μm-thick aluminum foil (JIS 1N30-H18) using a comma coater, and the resulting film was then dried. By sintering the aluminum foil thus obtained in an argon gas atmosphere at 635° C. for 7 hours, a porous aluminum material (electrode material) was obtained. The thickness of the sintered electrode material was about 130 μm (substrate: 30 μm, sintered body: 50 μm on each surface of the substrate)

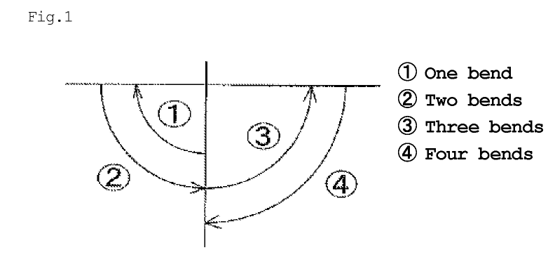

The bending strength of each electrode material (before chemical conversion treatment) was measured. The bending strength was measured in accordance with the MIT Automatic Folding Endurance Test defined by the Electronic Industries Association of Japan (EIAJ RC-2364A). The test was conducted using the MIT Folding Endurance Tester specified in JIS P8115. In this test, the number of bends at the point of breaking was determined as the bending strength of each electrode material. The number of bends was counted as shown in FIG. 1. Specifically, when a test piece was bent 90°, the number of bends was counted as one, when the test piece was returned to the original position, the number of bends became two, when the test piece was bent 90° toward the opposite direction, the number of bends became three, and when the test piece was returned to the original position again, the number of bends was counted as four. Table 1 shows the bending strength measurement results.

Thereafter, electrode materials were prepared separately from those used in the bending strength test. A chemical conversion coating was applied to these materials in a boric acid aqueous solution (50 g/L) at 250 V. The bending strength of each electrode material after the application of the chemical conversion coating was also measured in the same manner as described above. Table 1 shows the measurement results of the bending strength.

The electrostatic capacity of each electrode material after the application of the chemical conversion coating was measured using an ammonium borate aqueous solution (3 g/L). The projected area measured was 10 cm². Table 1 shows the results of the measured electrostatic capacity values.

TABLE 1

| | Si concentration | Bending strength | Bending strength after | Electrostatic |
|---|---|---|---|---|
| | in Al alloy | before application of chemical | application of chemical | capacity |
| | (ppm by weight) | conversion coating (times) | conversion coating (times) | (μF/10 cm²) |
| Comparative | 50 | 45 | 0 | 29 |
| Example 1 | | | | |
| Example 1 | 110 | 58 | 0 | 30 |
| Example 2 | 240 | 58 | 17 | 29 |
| Example 3 | 400 | 58 | 53 | 30 |
| Example 4 | 650 | 62 | 71 | 29 |
| Example 5 | 1000 | 85 | 100 | 28.5 |
| Example 6 | 2100 | 133 | 150 | 27 |

As is clear from the results of Table 1, the bending strength can be improved both before and after the application of the chemical conversion coating by increasing the Si concentration in the aluminum alloy. It is also clear that the increase of the Si concentration does not substantially affect the electrostatic capacity measurement results.

Generally, when the chemical conversion voltage increases, the strength of the electrode material decreases. However, by increasing the Si concentration, the strength of the electrode material can be maintained even when the chemical conversion voltage is increased.

### Examples 1-2 to 1-6

In Example 1 (Si concentration: 110 ppm by weight), an aluminum alloy powder having an average particle diameter of 3 μm was used. Table 2 shows the changes in the bending strength and electrostatic capacity before and after the application of the chemical conversion coating for different average particle diameters. Table 2 shows the measurement results.

TABLE 2

| | Average particle | Bending strength before | Bending strength after | Electrostatic |
|---|---|---|---|---|
| | diameter (μm) of | application of chemical | application of chemical | capacity |
| | Al alloy powder | conversion coating (times) | conversion coating (times) | (μF/10 cm²) |
| Example 1 | 3 | 58 | 0 | 30 |
| Example 1-2 | 4 | 72 | 3 | 25 |
| Example 1-3 | 5 | 85 | 4 | 21.8 |
| Example 1-4 | 6.3 | 83 | 7 | 21.5 |
| Example 1-5 | 6.9 | 87 | 12 | 20 |
| Example 1-6 | 9 | 128 | 30 | 16.6 |

As is clear from the results shown in Table 2, when the average particle diameter of the aluminum alloy powder increases, the electrostatic capacity decreases (this change is attributable to the decrease in the specific surface area). In contrast, when the average particle diameter increases, the bending strength increases both before and after the application of the chemical conversion coating. Accordingly, by increasing the average particle diameter within the extent that is allowed by the electrostatic capacity, the bending strength can be enhanced while maintaining the necessary electrostatic capacity.

1. A porous aluminum material comprising a sintered body of an aluminum alloy having an Si content of 100 to 3,000 ppm by weight.

2. The porous aluminum material according to claim 1, wherein the sintered body is formed by sintering the aluminum alloy particles while maintaining a space between each particle.

3. The porous aluminum material according to claim 1, wherein the sintered body is a foil having an average thickness of not less than 20 μm and not more than 1,000 μm.

4. The porous aluminum material according to claim 1, which further comprises a substrate for supporting the aluminum material.

5. The porous aluminum material according to claim 4, wherein the substrate is an aluminum foil.

6. The porous aluminum material according to claim 1, which is an electrode material for an aluminum electrolytic capacitor.

7. The porous aluminum material according to claim 1, which is a catalyst support.

8. A method for producing a porous aluminum material, comprising the steps of:
Step (1): forming a film made from a composition comprising an aluminum alloy powder having an Si content of 100 to 3,000 ppm by weight on a substrate; and
Step (2): sintering the film at a temperature not lower than 560° C. and not higher than 660° C.

9. The production method according to claim 8, wherein the powder has an average particle diameter of not less than 0.5 μm and not more than 100 μm.

10. The production method according to claim 8, wherein the composition comprises at least one member selected from the group consisting of resin binders and solvents.
